(19) United States
(12) Patent Application Publication
(10) Pub. No.: US 2015/0123875 A1
(43) Pub. Date: May 7, 2015

(54) POWER MANAGEMENT DEVICE AND METHOD

(71) Applicant: Wistron Corp., New Taipei City (TW)

(72) Inventor: Tsung-Jung Wang, New Taipei City (TW)

(73) Assignee: Wistron Corp., New Taipei City (TW)

(21) Appl. No.: 14/256,865

(22) Filed: Apr. 18, 2014

(30) Foreign Application Priority Data
Nov. 5, 2013 (TW) 102140039

(51) Int. Cl. G06F 1/32; G09G 5/00

(52) U.S. Cl. CPC G06F 1/3218; G09G 5/003; G09G 2330/021
USPC 345/1.3

(57) ABSTRACT

A power management device and method are provided. The power management device for a flip electrical device, which has a lid part and a main part, includes: a sensing unit, configured to detect whether the lid part and the main part are overlapped, and generate a notification signal when the lid part and the main part are overlapped; an operation unit, configured to detect whether the flip electrical device is connected to an external display device according to the notification signal, and generate a detecting result, and when a defined condition is conformed, the operation unit is operated in an operating mode and transmits image data to the external display device, wherein the defined condition includes a set function being enabled, and the detecting result is that the flip electrical device is connected to the external display device.

### CROSS REFERENCE TO RELATED APPLICATIONS

This application claims priority of Taiwan Patent Application No. 102140039, filed on Nov. 5, 2013, the entirety of which is incorporated by reference herein.

### BACKGROUND OF THE DISCLOSURE

1. Field of the Disclosure

The disclosure generally relates to power management technology, and more particularly to technology that detects whether connecting with the external display device to execute different modes when the flip electrical device is overlapped.

2. Description of the Related Art

The flip electrical devices are more and more popular, and there are more and more users using flip electrical devices. When users use the flip electrical device, the effective power management of the flip electrical device can provide more efficient and convenient operation.

One of the advantages of the flip electrical device is that it is highly movable. Therefore, the flip electrical device usually is configured with the smaller screen. However, some users who like a larger size screen may connect the flip electrical device with the external display device which has larger size screen for replacing the original screen of the flip electrical device. Therefore, users may sometimes need to watch the external display device and cover the upper lid or external lid of the flip electrical device. But, the user does not desire the flip electrical device to switch to a power-saving standby mode when the upper lid or external lid of the flip electrical device is covered. However, the current flip electrical device doesn't have a power management function for auto-detecting whether it is connecting the external display device, and it is not convenient for users. Therefore, how to provide an efficient and convenient power management method may be an important subject.

### BRIEF SUMMARY OF THE DISCLOSURE

Power management technology of detecting whether connecting with the external display device to execute different modes when the upper lid or external lid of the flip electrical device is overlapped is provided to overcome the above-mentioned problems.

An embodiment of the disclosure provides a power management device for a flip electrical device, wherein the flip electrical device comprises a lid part and a main part, comprising: a sensing unit, configured to detect whether the lid part and the main part are overlapped and generate a notification signal when the lid part and the main part are overlapped; and an operation unit, configured to detect whether the flip electrical device is connected an external display device according to the notification signal and generate a detecting result, and when a defined condition is conformed, the operation unit operates in an operating mode, and transmits image data to the external display device, wherein the defined condition comprises that a set function is enabled, and the detecting result is that the flip electrical device is connected to the external display device

An embodiment of the disclosure provides a power management device for a flip electrical device, wherein the flip electrical device comprises a lid part and a main part, comprising: a sensing unit, configured to detect whether the lid part and the main part are overlapped and generate a notification signal when the lid part and the main part are overlapped; a read only memory; and a processor, configured to execute a basic input/output system and an operating system, wherein the basic input/output system detects whether the flip electrical device is connected with an external display device according to the notification and generates a detecting result in the read only memory, and the operating system obtains the detecting result and the notification signal by a ACPI code and when a defined condition is conformed, the operating system makes the processor operate in an operating mode by the ACPI code, and transmit image data to the external display device wherein the defined condition comprises that a set function is enabled, and the detecting result is that the flip electrical device is connected to the external display device.

An embodiment of the disclosure provides a power management method for a flip electrical device, wherein the flip electrical device comprises a lid part and a main part, comprising: detecting whether the lid part and the main part are overlapped; generating a notification signal when the lid part and the main part are overlapped; detecting whether the flip electrical device is connected to an external display device according to the notification signal and generating a detecting result; determining whether a defined condition is conformed; and operating the operation unit in an operating mode, and transmitting image data to the external display device, when a defined condition is conformed, wherein the defined condition comprises that a set function is enabled, and the detecting result is that the flip electrical device is connected to the external display device.

An embodiment of the disclosure provides a power management method for a flip electrical device, wherein the flip electrical device comprises a lid part and a main part, comprising: detecting whether the lid part and the main part are overlapped generating a notification signal when the lid part and the main part are overlapped; executing a basic input/output system to detect whether the flip electrical device is connected with an external display device according to the notification and generate a detecting result in a read only memory; executing an operating system to obtain the detecting result and the notification signal by a ACPI code and determine whether a defined condition is conformed; and operating the flip electrical device in an operating mode by the ACPI code by the operating system, and transmitting image data to the external display device when a defined condition is conformed, wherein the defined condition comprises that a set function is enabled, and the detecting result is that the flip electrical device is connected to the external display device.

### BRIEF DESCRIPTION OF THE DRAWINGS

The disclosure will become more fully understood by referring to the following detailed description with reference to the accompanying drawings, wherein:

FIG. 1 is a block diagram of a power management device according to an embodiment of the disclosure;

FIG. 2 is a block diagram of a power management device according to another embodiment of the disclosure;

FIG. 3 is a flow chart illustrating a power management method according to an embodiment of the disclosure;

FIG. 4 is a flow chart illustrating a power management method according to another embodiment of the disclosure.

### DETAILED DESCRIPTION OF THE DISCLOSURE

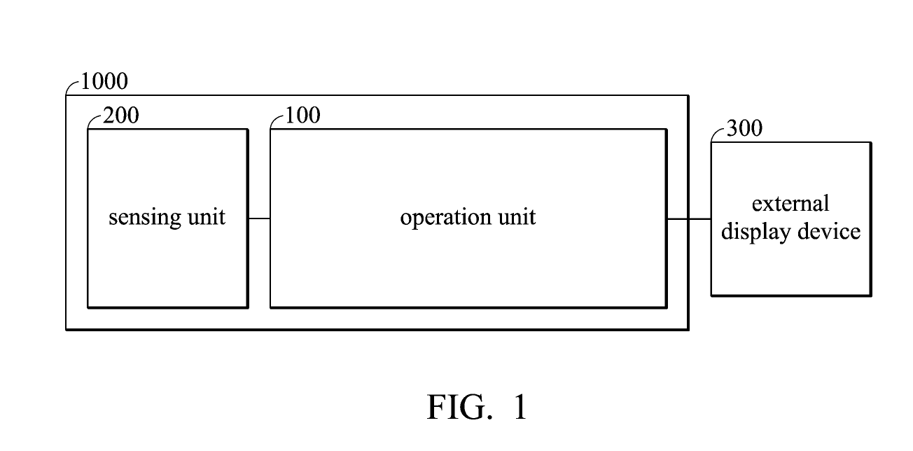

FIG. 1 is a block diagram of a power management device according to an embodiment of the disclosure. The power management device is applied to a flip electrical device 1000, wherein the flip electrical device comprises a lid part and a main part. The flip electrical device 1000 may be a note book, smart phone, personal digital assistant (PDA) and so on, and the disclosure is not limited thereto. For those who are skilled in this technology, the flip electrical device 1000 also can apply on a flip computer-system-configuration, such as hand-held devices, portable devices, PDAs, multi-processor system, microprocessor-based or programmable consumer electronics and similar apparatus. The flip electrical device 1000 comprises an operation unit 100, a sensing unit 200.

The operation unit 100 may comprise a single central-processing unit (CPU) or a plurality of parallel processing unit of parallel processing environment. Memory comprises read only memory (ROM), flash memory and/or random access memory (RAM), and is configured to store the program modules executed by the operation unit 100. Generally, the program modules comprise routines, program, object, component or Web Service and so on.

The sensing unit 200 is configured to detect the whether the lid part and the main part of the flip electrical device 1000 are overlapped, and generate a notification signal when the lid part and the main part are overlapped, and transmit the notification signal to the operation unit 100. For example, the sensing unit 200 may be a magnetic sensing unit which is configured to the lid part and the main part of the flip electrical device 1000 and it can detect whether the lid part and the main part of the flip electrical device 1000 are overlapped according to the magnetic variety which is caused by opening or closing the lid part and the main part, but the disclosure is not limited thereto. In the other embodiments of the disclosure, the sensing unit 200 may be an infrared light device, a light-sensing device, a sensing-switch or other sensing unit, which detects whether the lid part and the main part of the flip electrical device 1000 are overlapped according to the physical variety which is caused by opening or closing the lid part and the main part.

Note that, the flip electrical device 1000 also can be a tablet, wherein the tablet combines with an external device for forming an electrical system with the lid part and the main part. For example, the tablet can be installed a smart cover to have the feature of the flip electrical device. In other words, the smart cover is the lid part or the main part of the flip electrical device 1000. Note that, the smart cover can be regarded as an element of the flip electrical device 1000, or the smart cover is not comprised in the flip electrical device 1000. Even though the smart cover is not comprised in the flip electrical device 1000, the sensing unit 200 may detect whether the smart cover regarded as the lid part or the main part is closed according to each kind of the physical variety. The sensing unit 200 may also generate the notification signal, and transmit the notification signal to the operation unit 100. In another embodiment, the tablet can be combined with a keyboard or another tablet to have the feature of the flip electrical device. Note that the keyboard or another tablet can be regarded as an element of the flip electrical device 1000, or the keyboard or another tablet is not comprised in the flip electrical device 1000. Even though the keyboard or another tablet is not comprised in the flip electrical device 1000, the sensing unit 200 may detect whether the keyboard or another tablet regarded as the lid part or the main part is closed according to each kind of the physical variety. The sensing unit 200 may also generate the notification signal, and transmit the notification signal to the operation unit 100.

In an embodiment of the disclosure, the operation unit 100 detects whether the flip electrical device 1000 is connected with an external display device 300 according to the notification signal and generates a detecting result. When a defined condition is conformed, the operation unit 100 operates in an operating mode, and transmits image data to the external display device 300. At this time, the user can obtain a larger display screen by the external display device 300. In an embodiment of the disclosure, the defined condition comprised that a set function is enabled, and the detecting result is that the flip electrical device 1000 is connected to the external display device 300. For example, the set function may be a system operation option of the flip electrical device 1000, but the disclosure is not limited thereto. In another embodiment of the disclosure, when the defined condition is not conformed, the operation unit 100 operates in a standby mode, and stop transmitting image data to the external display device 300 for saving the power consumption of the flip electrical device 1000, wherein the defined condition is not conformed is meant that the set function is not enabled, or the set function is enabled but the detecting result is that the flip electrical device 1000 is not connected to the external display device 300.

In an embodiment of the disclosure, the detecting result is generated by detecting a voltage level of detecting pins of a video port (not presented) for determining whether the video terminal (not presented) is connected with the video port to know whether the flip electrical device 1000 is connected to the external display device 300.

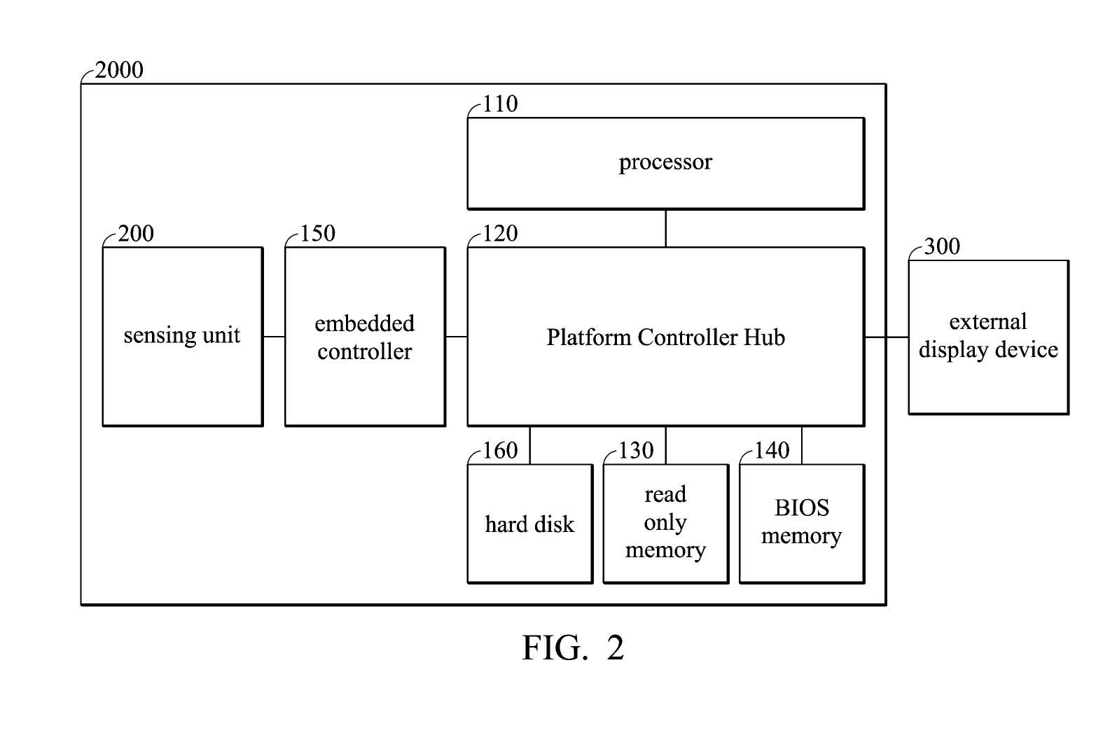

FIG. 2 is a block diagram of a power management device according to another embodiment of the disclosure. The power management device is applied to a flip electrical device 2000, wherein the flip electrical device comprises a lid part and a main part. The flip electrical device 2000 may be a note book, smart phone, personal digital assistant (PDA) and so on, and the disclosure is not limited thereto. For those who are skilled in this technology, the flip electrical device 2000 also can apply on a flip computer-system-configuration, such as hand-held devices, portable devices, PDAs, multi-processor system, microprocessor-based or programmable consumer electronics and similar apparatus. The flip electrical device 2000 comprises a processor 110, a Platform Controller Hub (PCH) 120, a read only memory 130, a BIOS memory 140, an embedded controller 150, a hard disk 160 and a sensing unit 200.

In the computer system (such as the electrical device installed the Microsoft Windows operating system), the power management can reduce the power consumption by operating in a Standby mode defined in the Advanced Configuration and Power Interface (ACPI). In the Advanced Configuration and Power Interface, six states S0˜S5 are defined. Turn-on state S0 is meant that the computer system is in working state. In the turn-on state, processor 110 executes the order and the operating system and application program also can execute normally. In addition, in the turn-on state, processor 110 and hard disk 160 can switch to the low-power state and switch from the low-power state once again. In power saving state S2, the processor 110 is turned off and does not provide power. In the sleep state S3, only random access memory (RAM) (not presented) provides power (also regard as Suspend to RAM). The sleep state S3 is a kind of the sleep state with low Resume-time (5 sec or shorter). The computer system can recover to the working state (such as S0 state) instantly. The Hibernate state S4 (also called Suspend to Disk) is a kind of the sleep state with low power consumption and high Resume-time (20 sec or longer). The state S0˜S4 are different levels of power-saving state or sleep state. S5 state is turn-off state. In the turn-off state S5, the program and devices of the computer are turned off, but some elements still charged to make computer still can be resumed by partial of the peripheral devices. Note that, the turn-on state, sleep state, power-saving state and turn-off state in the disclosure are not limited to the Microsoft Windows operating system defined in ACPI. For example, In the Linux operating system or Mac operating system, in all kinds of power management program, the state of Suspend to RAM defined may be regarded as the sleep state of the disclosure, and the state of Suspend to Disk defined may be regarded as the Hibernate state of the disclosure. Note that, the power-saving state, sleep state and Hibernate state are regarded as standby mode and the turn-on state and the working state can be regarded as the operating mode.

The processor 110 may comprise random processing memory (not presented) and load the programs of the read only memory 130, the BIOS memory 140 and the hard disk 160 to the random processing memory by the Platform Controller Hub 120.

The Platform Controller Hub 120 is coupled with the processor 110 and other devices, such as the read only memory 130, the BIOS memory 140, the embedded controller 150 and the hard disk 160. The Platform Controller Hub 120 is configured to encode/decode the files for other devices can communicate with the processor 110, determine the executed order of the procedures and transmit the instructions of the processor 110 to the other devices of the flip electrical device 2000.

The read only memory 130 is configured to store the parameters of the flip electrical device 2000. For example, the read only memory 130 may be an Electrically-Erasable Programmable Read-Only Memory (EEPROM), but the disclosure is not limited thereto. The read only memory 130 may be other types of the non-volatile memory.

The BIOS memory 140 is configured to save source codes of a Basic Input/Output System (BIOS) for providing the source code of the Basic Input/Output System to processor 110 by the Platform Controller Hub 120. For example, the BIOS memory 140 may be a Serial Peripheral Interface Read-Only Memory (SPI ROM), but the disclosure is not limited thereto. The BIOS memory 140 may be other types of the non-volatile memory.

The embedded controller 150 is configured to receive the detecting signal from the sensing unit 200, and transmit the detecting signal to the processor 110 by the Platform Controller Hub 120.

The hard disk 160 is configured to store the programs of the flip electrical device 2000, such as the operating system (OS), driver and other application program. Note that, in the disclosure, the hard disk 160 further comprises an Advanced Configuration and Power Interface (ACPI) code.

The sensing unit 200 is coupled to the embedded controller 150, and is configured to detect the whether the lid part and the main part of the flip electrical device 2000 are overlapped, and generate a notification signal to the embedded controller 150 when the lid part and the main part are overlapped, and transmit the notification signal to the processor 110 by the Platform Controller Hub 120. For example, the sensing unit 200 may be a magnetic sensing unit which is configured to the lid part and the main part of the flip electrical device 2000 and it can detect whether the lid part and the main part of the flip electrical device 2000 are overlapped according to the magnetic variety which is caused by opening or closing the lid part and the main part, but the disclosure is not limited thereto. In the other embodiments of the disclosure, the sensing unit 2000 may be an infrared light device, a light-sensing device or other sensing unit, which detects whether the lid part and the main part of the flip electrical device 2000 are overlapped according to the physical variety which is caused by opening or closing the lid part and the main part.

Note that, the flip electrical device 2000 also can be a tablet, wherein the tablet combines with an external device for forming an electrical system with the lid part and the main part. For example, the tablet can be installed a smart cover to have the feature of the flip electrical device. In other words, the smart cover is the upper lid or the lower lid of the flip electrical device 2000. Note that, the smart cover can be regarded as an element of the flip electrical device 2000, or the smart cover is not comprised in the flip electrical device 2000. Even though the smart cover is not comprised in the flip electrical device 2000, the sensing unit 200 may detect whether the smart cover regarded as the upper lid or the lower lid is opened according to each kind of the physical variety. The sensing unit 200 may also generate the notification signal, and transmit the notification signal to the embedded controller 150. In another embodiment, the tablet can be combined with a keyboard or another tablet to have the feature of the flip electrical device. Note that the keyboard or another tablet can be regarded as an element of the flip electrical device 2000, or the keyboard or another tablet is not comprised in the flip electrical device 2000. Even though the keyboard or another tablet is not comprised in the flip electrical device 2000, the sensing unit 200 may detect whether the keyboard or another tablet regarded as the upper lid or the lower lid is closed according to each kind of the physical variety. The sensing unit 200 may also generate the notification signal, and transmit the notification signal to the embedded controller 150.

In an embodiment of the disclosure, the processor 110 executes a Basic Input/Output System to detect whether the flip electrical device 2000 is connected with an external display device 300 according to the notification signal and generates a detecting result in the read only memory 130. When the operating system executed by the processor 110 obtains the notification signal and the detecting result in the read only memory 130 by a ACPI code to determine that when a defined condition is conformed, operation system make the processor 110 operate in an operating mode by the ACPI code, and transmits image data to the external display device 300. At this time, the user can obtain a larger display screen by the external display device 300. In an embodiment of the disclosure, the defined condition comprised that a set function of the operating system is enabled, and the detecting result is that the flip electrical device 2000 is connected to the external display device 300. For example, the set function may be a system operation option of the flip electrical device 2000, but the disclosure is not limited thereto. In another embodiment of the disclosure, when the defined condition is not conformed, the operation system make the processor 110 operate in an standby mode by the ACPI code, and stop transmitting image data to the external display device 300 for saving the power consumption of the flip electrical device 2000, wherein the defined condition is not conformed is meant that the set function of the operating system is not enabled, or the set function of the operating system is enabled but the detecting result is that the flip electrical device 2000 is not connected to the external display device 300. In an embodiment of the disclosure, when the flip electrical device 2000 is connected with the external display device 300, if the user desires to move the flip electrical device 2000, the user does not need to modify the set function manually, and he only needs to overlap the lid part and the main part and remove the external display device 300. The processor may execute the operating system to determine the defined condition, and the flip electrical device 2000 is operated in a standby mode for saving the power consumption. In an embodiment of the disclosure, the operating mode may be regarded as the turn-on state S0 defined in the ACPI and the standby mode may be regarded as the power-saving state S1, sleep state S3 and Hibernate state S3, but the disclosure is not limited thereto.

In an embodiment of the disclosure, the processor 110 detects voltage level of detecting pins of a video port (not presented) and generates the detecting result in the read only memory 130 for determining whether the video terminal (not presented) is connected with the video port to know whether the flip electrical device 2000 is connected to the external display device 300. Note that, the video port and the video terminal comprise every different form, such as, D-sub contactor, Digital Visual Interface (DVI), High Definition Multimedia Interface (HDMI), Display Port, Mini Display Port, and so on, but the disclosure is not limited thereto. In an embodiment of the disclosure, when the video port of the flip electrical device 2000 is connected with the video terminal of the external display device 300, the Platform Controller Hub 120 detect the voltage level of detecting pins of a video port is 3.3V or 5V, and when the video port of the flip electrical device 2000 is not connected with the video terminal of the external display device 300, the Platform Controller Hub 120 detect the voltage level of detecting pins of the video port is 0V, but the disclosure is not limited thereto. In an embodiment of the disclosure, the detecting pin of the video port of the High Definition Multimedia Interface (HDMI) is pin 19, the detecting pin of the video port of the Display Port is pin 18, and the detecting pin of the video port of the Mini Display Port is pin 2, but the disclosure is not limited thereto.

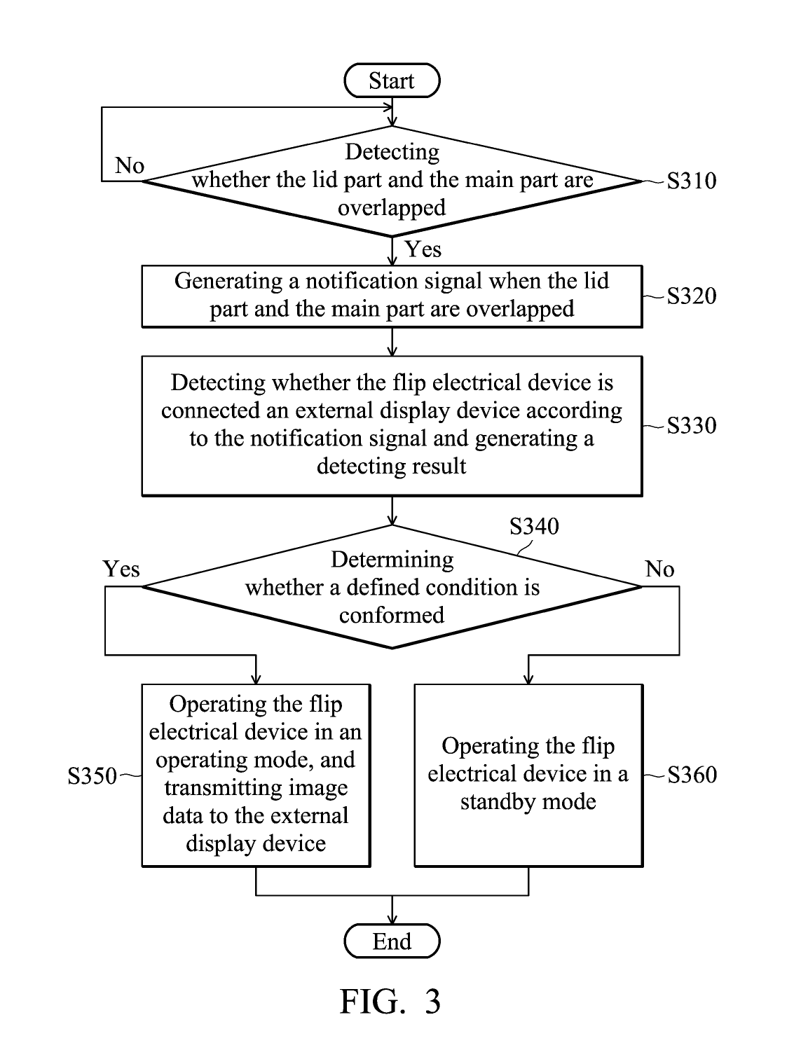

FIG. 3 is a flow chart illustrating a power management method according to an embodiment of the disclosure. The power management method is applied for the flip electrical device 1000 of the FIG. 1, wherein the flip electrical device comprises a lid part and a main part. The flow chart is started at step S300.

In step S310, The sensing unit 200 is configured to detect the whether the lid part and the main part of the flip electrical device 1000 are overlapped. If the lid part and the main part of the flip electrical device 1000 are overlapped, the flow is processed step S320. Otherwise, the sensing unit 200 detects the whether the lid part and the main part of the flip electrical device 1000 are overlapped again.

Then, in step S320, the sensing unit 200 generates a notification signal and transmits the notification signal to the operation unit 100.

Then, in step S330, the operation unit 100 detects whether the flip electrical device 1000 is connected with an external display device 300 according to the notification signal and generates a detecting result.

Then, in the step S340, the operation unit 100 determines whether a defined condition is conformed. If the defined condition is conformed, the flow is processed step S350. Otherwise, the flow is processed step S360.

When the defined condition is conformed, the flow is processed step S350. In step S350, the flip electrical device 1000 operates in an operating mode, and transmits image data to the external display device 300, wherein the defined condition comprised that a set function is enabled, and the detecting result is that the flip electrical device 1000 is connected to the external display device 300. The flow chart is ended at step S350.

When the defined condition is not conformed, the flow is processed step S360. In step S360, the flip electrical device 1000 operates in a standby mode, wherein the defined condition is not conformed is meant that the set function is not enabled, or the set function is enabled but the detecting result is that the flip electrical device 1000 is not connected to the external display device 300. The flow chart is ended at step S360.

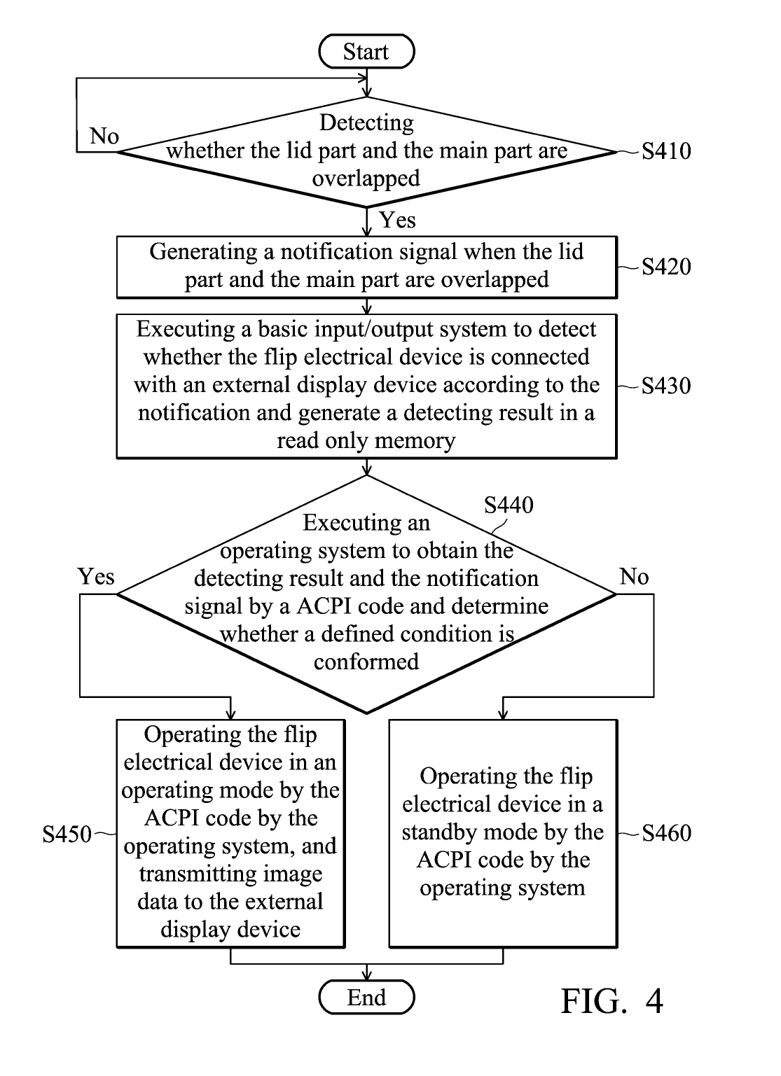

FIG. 4 is a flow chart illustrating a power management method according to an embodiment of the disclosure. The power management method is applied for the flip electrical device 2000 of the FIG. 2, wherein the flip electrical device comprises a lid part and a main part. The flow chart is started at step S400.

In step S410, the sensing unit 200 is configured to detect the whether the lid part and the main part of the flip electrical device 2000 are overlapped. If the lid part and the main part of the flip electrical device 1000 are overlapped, the flow is processed step S420. Otherwise, the sensing unit 200 detects the whether the lid part and the main part of the flip electrical device 2000 are overlapped again.

Then, in step S420, the sensing unit 200 generates a notification signal to the embedded controller 150 and transmits the notification signal to the processor 110 by the Platform Controller Hub 120.

Then, in step S430, the processor 110 is configured to execute a Basic Input/Output System to detect whether the flip electrical device 2000 is connected with an external display device 300 according to the notification signal generated by the sensing unit 200 and generate a detecting result in the read only memory 130.

Then, in the step S440, the processor 110 executes the operating system and obtains the notification signal and the detecting result by an ACPI code to determine whether a defined condition is conformed. If the defined condition is conformed, the flow is processed step S450. Otherwise, the flow is processed step S460.

When the defined condition is conformed, the flow is processed step S450. In step S450, when a defined condition is conformed, operation system make the processor 110 of the flip electrical device 2000 operate in an operating mode by the ACPI code, and transmits image data to the external display device 300, wherein the defined condition comprised that a set function of the operating system is enabled, and the detecting result is that the flip electrical device 2000 is connected to the external display device 300. The flow chart is ended at step S450

When the defined condition is not conformed, the flow is processed step S460. In step S460, the operation system make the processor 110 of the flip electrical device 2000 operate in an standby mode by the ACPI code, wherein the set function of the operating system is not enabled, or the set function of the operating system is enabled but the detecting result is that the flip electrical device 2000 is not connected to the external display device 300. The flow chart is ended at step S460.

The methods of the disclosure certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the disclosure has been described by way of example and in terms of the preferred embodiments, it is to be understood that the disclosure is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power management device for a flip electrical device, wherein the flip electrical device comprises a lid part and a main part, comprising:
a sensing unit, configured to detect whether the lid part and the main part are overlapped and generate a notification signal when the lid part and the main part are overlapped; and
an operation unit, configured to detect whether the flip electrical device is connected an external display device according to the notification signal and generate a detecting result, and when a defined condition is conformed, the operation unit operates in an operating mode, and transmits image data to the external display device,
wherein the defined condition comprises that a set function is enabled, and the detecting result is that the flip electrical device is connected to the external display device.

2. The power management device of claim 1, wherein the defined condition not being conformed comprises that the set function is not enabled, or the set function is enabled but the detecting result is that the flip electrical device is not connected to the external display device, wherein in the condition, the operation unit operates in a standby mode.

3. The power management device of claim 2, wherein the detecting result is generated by detecting a voltage level of detecting pins of a video port for determining whether a video terminal is connected to the video port to know whether the flip electrical device is connected to the external display device.

4. The power management device of claim 1, wherein the detecting result is generated by detecting a voltage level of detecting pins of a video port for determining whether a video terminal is connected to the video port to know whether the flip electrical device is connected to the external display device.

5. A power management device for a flip electrical device, wherein the flip electrical device comprises a lid part and a main part, comprising:
a sensing unit, configured to detect whether the lid part and the main part are overlapped and generate a notification signal when the lid part and the main part are overlapped;
a read only memory; and
a processor, configured to execute a basic input/output system and an operating system, wherein the basic input/output system detects whether the flip electrical device is connected with an external display device according to the notification and generates a detecting result in the read only memory, and the operating system obtains the detecting result and the notification signal by a ACPI code and when a defined condition is conformed, the operating system makes the processor operate in an operating mode by the ACPI code, and transmit image data to the external display device,
wherein the defined condition comprises that a set function is enabled, and the detecting result is that the flip electrical device is connected to the external display device.

6. The power management device of claim 5, wherein the defined condition is not conformed comprises that the set function is not enabled, or the set function is enabled but the detecting result is that the flip electrical device is not connected to the external display device, wherein in the condition, the operation unit operates in a standby mode.

7. The power management device of claim 6, further comprising:
a platform controller hub; and
an embedded controller, configured to receive the notification signal and transmit the notification signal to the processor by the platform controller hub.

8. The power management device of claim 7, wherein the detecting result is generated by detecting a voltage level of detecting pins of a video port by the platform controller hub for determining whether a video terminal is connected to the video port to know whether the flip electrical device is connected to the external display device.

9. The power management device of claim 8, wherein the detecting pins are connected to the platform controller hub and the processor detects whether the flip electrical device is connected to the external display device by the platform controller hub.

10. The power management device of claim 5, further comprising:
a platform controller hub; and
an embedded controller, configured to receive the notification signal and transmit the notification signal to the processor by the platform controller hub.

11. The power management device of claim 10, wherein the detecting result is generated by detecting a voltage level of detecting pins of a video port by the platform controller hub for determining whether a video terminal is connected to the video port to know whether the flip electrical device is connected to the external display device.

12. The power management device of claim 11, wherein the detecting pins are connected to the platform controller hub and the processor detects whether the flip electrical device is connected to the external display device by the platform controller hub.

13. A power management method for a flip electrical device, wherein the flip electrical device comprises a lid part and a main part, comprising:
detecting whether the lid part and the main part are overlapped;
generating a notification signal when the lid part and the main part are overlapped;
detecting whether the flip electrical device is connected an external display device according to the notification signal and generating a detecting result;
determining whether a defined condition is conformed; and
operating the flip electrical device in an operating mode, and transmitting image data to the external display device, when a defined condition is conformed,
wherein the defined condition comprises that a set function is enabled, and the detecting result is that the flip electrical device is connected to the external display device.

14. The power management method of claim 13, wherein the defined condition is not conformed comprises that the set function is not enabled, or the set function is enabled but the detecting result is that the flip electrical device is not connected to the external display device, wherein in the condition, the flip electrical device operates in a standby mode.

15. The power management method of claim 14, further comprising: detecting a voltage level of detecting pins of a video port for determining whether a video terminal is connected to the video port to know whether the flip electrical device is connected to the external display device.

16. The power management method of claim 13, further comprising: detecting a voltage level of detecting pins of a video port for determining whether a video terminal is connected to the video port to know whether the flip electrical device is connected to the external display device.

17. A power management method for a flip electrical device, wherein the flip electrical device comprises a lid part and a main part, comprising:
detecting whether the lid part and the main part are overlapped
generating a notification signal when the lid part and the main part are overlapped;
executing a basic input/output system to detect whether the flip electrical device is connected with an external display device according to the notification and generate a detecting result in a read only memory;
executing an operating system to obtain the detecting result and the notification signal by a ACPI code and determine whether a defined condition is conformed; and
operating the flip electrical device in an operating mode by the ACPI code by the operating system, and transmitting image data to the external display device when a defined condition is conformed,
wherein the defined condition comprises that a set function is enabled, and the detecting result is that the flip electrical device is connected to the external display device.

18. The power management method of claim 17, wherein the defined condition is not conformed comprises that the set function is not enabled, or the set function is enabled but the detecting result is that the flip electrical device is not connected to the external display device, wherein in the condition, the flip electrical device operates in a standby mode.

19. The power management method of claim 18, further comprising: detecting a voltage level of detecting pins of a video port for determining whether a video terminal is connected to the video port to know whether the flip electrical device is connected to the external display device.

20. The power management method of claim 17, further comprising: detecting a voltage level of detecting pins of a video port for determining whether a video terminal is connected to the video port to know whether the flip electrical device is connected to the external display device.
